(19) United States
(12) Patent Application Publication
(10) Pub. No.: US 2007/0278883 A1
(43) Pub. Date: Dec. 6, 2007

(54) Rotor, Related Manufacturing Process, And Induction Machine Employing The Rotor

(76) Inventors: Piero Marcenaro, Montefalcone (IT); Antonio Odorico, Montefalcone (IT)

Correspondence Address: YOUNG & THOMPSON, 745 SOUTH 23RD STREET, 2ND FLOOR, ARLINGTON, VA, 22202, US

(21) Appl. No.: 11/791,153

(22) PCT Filed: Nov. 24, 2004
(86) PCT No.: PCT/IT04/00647

§ 371 Date: May 21, 2007

(30) Foreign Application Priority Data
Nov. 22, 2004 (IT) RM2004A000571

(51) Int. Cl. H02K 1/06; H02K 1/02; H02K 1/22; H02K 15/02

(52) U.S. Cl. 310/90; 29/598; 310/166; 310/262

(57) ABSTRACT

A rotor (7) for induction machines, includes a core (10), apt to face a stator (5) of an induction machine, and an axis (8) that is coaxial with the core (10). The core (10) and the axis (8) are made enbloc, and in that it includes a jacket (11) externally integrally coupled to the core (10), the jacket (11) including conductive metallic matrix incorporating reinforcing fibres (17). Also described is the process for manufacturing such a rotor, and the induction machine employing the rotor.

The present invention concerns a rotor, and the related induction machine (such as a generator or a motor), which is apt to rotate at very high speed, having high heat dissipation, high mechanical resistance, small electrical resistance, optimum magnetic properties, low weight and high stiffness, consequently allowing eliminating reduction gearboxes for coupling an external electromechanical machine (such as, for instance, a turbine, a compressor, or a pump) to the same rotor in electrical power generation systems.

The present invention further concerns the process for manufacturing such a rotor.

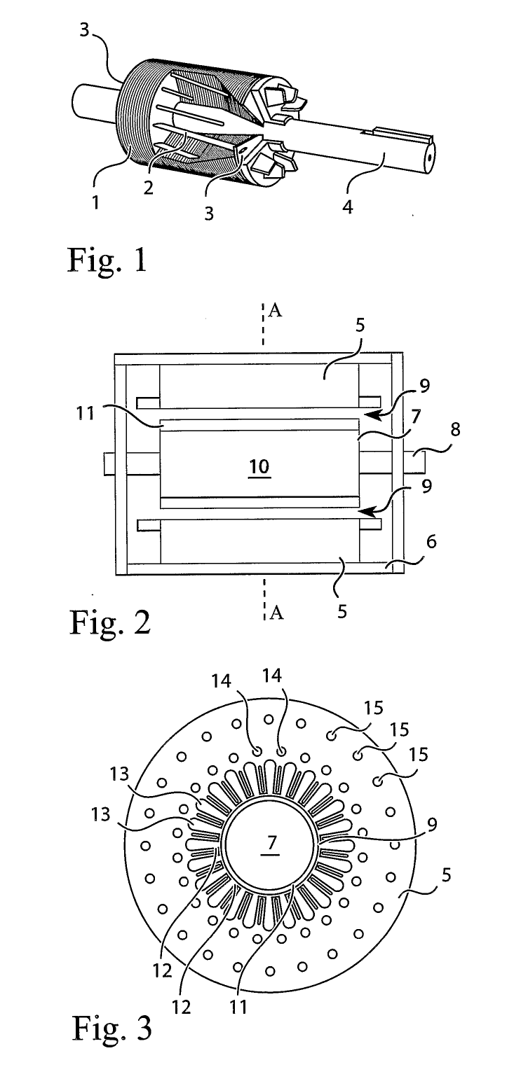

It is known that, as shown in FIG. 1, conventional squirrel cage rotors comprise an iron core 1 including an array of conductive bars 2 (usually of aluminium or copper) enclosed by a pair of conductive end rings 3 which are the ends of the core 1. The core 1 is made up of circular steel laminations provided with slots, for housing the bars 2, equally distributed along the lamination circumference. The laminations are piled up for forming the rotor body. As said, the stack is clamped by two end rings or plates 3, preferably of steel, fixed to the rotor shaft 4. Materials which are conventionally used in the field are steel, aluminium and copper. In particular, the rotor weight, that ranges from 500 to 2000 Kg for medium-size rotors, hinders its portability.

Conventional rotors, particularly the medium-size ones, are apt to operate at speeds only up to about 3000 or 3500 rpm (revolutions per minute), depending on the mains operation frequency (equal to 50 or 60 Hz respectively). In fact, at higher speeds there is a large increase in friction, temperature, inertial strength due to the significant weight of the rotor, axial deformations, and vibrations, which make the employment of such rotors impracticable. In particular, squirrel cage rotor configuration and employed materials do not provide an adequate heat dissipation.

Consequently, when these rotors are used in induction generator systems, they cannot be directly coupled to the turbines, for instance gas turbines, whose rated speeds are usually higher than 30,000 rpm.

Therefore, it is necessary to interpose a reduction gearbox between the turbine and the rotor.

However, the presence of the reduction gearbox entails some drawbacks.

First of all, it introduces significant mechanical stress for the components of the generator system, for example increasing its vibrations.

Inoltre, il reduction gearbox comporta una apprezzabile riduzione dell'efficienza meccanica del generator system.

Furthermore, the reduction gearbox emits high noise.

Still, the reduction gearbox increases the need for the maintenance of the generator system, requiring extremely frequent periodical controls, of the order of at least ten controls per year, with a consequent increase of the maintenance costs.

Finally, the reduction gearbox is a source of possible lubricant leakage involving a dangerous environmental impact.

Some solutions have been developed in order to try to solve the aforementioned drawbacks.

Japanese Patent Application No. JP 60059933-A discloses a rotor having a reduced weight, and the related manufacturing process, comprising two end flanges, made of a composite material of silicon whiskers and aluminium alloy, clamping the rotor body, made of a light-weight aluminium-silicon alloy.

European Patent Application No. EP 707752-A discloses a rotor having a cylindrical structure comprising fibre composite material wherein the magnetic filler material varies through the matrix of composite material so that the mass density of the structure decreases with distance radially from the axis of the rotor.

U.S. Pat. No. 6,384,507-B1 discloses a rotor having a coreless cylindrical structure comprising a squirrel cage conductive cylinder, made of aluminium or copper, and composite material or polymer resin. The cylinder comprises a plurality of axial slots into which the composite material or the polymer resin is inserted.

However, none of the cited developed solutions is capable to successfully solve the previously cited drawbacks of conventional rotors, all being further particularly complex.

It is therefore an object of the present invention to provide a rotor employable in induction machines, such as generators or motors, particularly of medium-size, which is apt to rotate at very high speed, so as to be capable to be directly coupled, when operating in a generator, to the shaft of a turbine, and, when operating in a motor of a high speed machine of the centrifugal type (as compressors and pumps), to the shaft of such a machine, i.e. without the interposition of reduction gearboxes, thus allowing high efficiency compact power conversion units to be achieved.

It is still an object of the present invention to provide such a rotor that has high heat dissipation, high mechanical resistance, small electrical resistance, optimum magnetic properties, low weight and high stiffness, reducing installation and maintenance costs of the induction machines using it.

It is still an object of the present invention to provide a process for manufacturing such a rotor.

It is specific subject matter of this invention a rotor for induction machines, comprising a core, apt to face a stator of an induction machine, and an axis that is coaxial with the core, characterised in that the core and the axis are made enbloc, and in that it further comprises a jacket externally integrally coupled to the core, the jacket comprising conductive metallic matrix incorporating reinforcing fibres.

Always according to the invention, the volume percentage of the metallic matrix may range from 10% to 75%, preferably from 50% to 60% of the jacket.

Still according to the invention, the metallic matrix may be made of at least one metallic material selected from the group comprising pure aluminium, aluminium-copper alloy, aluminium-silicon alloy, and alloy of aluminium and/or copper and/or magnesium and/or titanium and/or zinc and/or lead.

Preferably according to the invention, the metallic matrix is made of pure aluminium, or of aluminium comprising copper for about 2 wt. %.

Furthermore according to the invention, the reinforcing fibres may comprise continuous fibres and/or discontinuous fibres.

Always according to the invention, the reinforcing fibres may comprise monofilament fibres and/or multifilament fibres.

Still according to the invention, the reinforcing fibres may comprise at least one type of fibres selected from the group comprising alumina fibres, carbon fibres, silicon fibres.

Furthermore according to the invention, the reinforcing fibres may comprise substantially electrically insulating fibres.

Always according to the invention, the reinforcing fibres may comprise nanocrystalline fibres.

Still according to the invention, the nanocrystalline reinforcing fibres may have a diameter ranging from 10 to 12 μm.

Preferably according to the invention, the reinforcing fibres are monofilament continuous alumina fibres.

Furthermore according to the invention, the core and the axis may be made of a steel alloy.

Always according to the invention, the steel alloy of the core and the axis may comprise at least one metallic material selected from the group comprising nickel, chromium, molybdenum, carbon, and manganese.

It is still specific subject matter of this invention a process for manufacturing a rotor as previously described, characterised in that it comprises the following steps:
A. making the sole piece integrating the core and the axis;
B. winding the reinforcing fibres around a sacrificial cylinder, which has a diameter lower than the diameter of the core, obtaining a first semifinished product;
C. inserting the first semifinished product into a heated die of a casting system, further comprising a chamber provided with a crucible containing the metallic material of the matrix;
D. mechanically closing the die and creating a high vacuum condition in the casting system, by evacuating both the die and the chamber;
E. transferring the metallic material from the crucible into the die via a riser tube through the introduction of high-pressure nitrogen gas into the chamber;
F. removing the sacrificial cylinder, obtaining the jacket;
G. cooling the core at a first temperature at which its diameter is not larger than the jacket diameter at a second temperature; and
H. mounting the jacket on the core.

Always according to the invention, the process may further comprise, between step E and step F, a step of consolidating the metallic material through activation of at least one high-pressure hydraulic piston.

Still according to the invention, the process may further comprise, after step E and before step H, a step of turning the external surface of the jacket.

Furthermore according to the invention, the process may further comprise, after step F and before step H, a step of grinding the internal surface of the jacket.

Always according to the invention, in step G the core is cooled in a liquid nitrogen bath.

Still according to the invention, said second temperature may be room temperature.

Furthermore according to the invention, said second temperature may be higher than room temperature, the jacket being heated for assuming said second temperature.

It is further specific subject matter of this invention an induction machine, comprising a cylindrical stator, provided with winding coils, and a rotor, that is coaxial with the stator, between which an air gap is present, characterised in that the rotor is a rotor as previously described, the axis of the rotor being apt to be coupled to an external electromechanical machine.

Always according to the invention, the machine may further comprise an electrical frequency variation system interposed between, and connected to, the winding coils of the stator and an external mains.

Still according to the invention, said electrical frequency variation system may comprise a pulse width modulation or PWM type static converter, comprising semiconductor rectifier and inverter.

Furthermore according to the invention, the stator may be made with a laminated magnetic core.

Always according to the invention, the stator may comprise at least one series of ducts, operating as flow paths of a cooling system of the machine further comprising air blowing means.

Still according to the invention, the machine may further comprise grease lubricated single row radial ball bearings, apt to be adjustably preloaded.

Furthermore according to the invention, the machine may be apt to operate at rotor speeds up to about 35,000 revolutions per minute, or rpm.

Always according to the invention, the machine may be a poly-phase alternating current machine.

The present invention will now be described, by way of illustration and not by way of limitation, according to its preferred embodiment, by particularly referring to the Figures of the enclosed drawings, in which:

FIG. 1 shows a perspective view of a squirrel cage rotor according to the prior art;

FIG. 2 schematically shows, not to scale, a longitudinal sectional view of an induction machine employing a preferred embodiment of the rotor according to the invention;

FIG. 3 shows a transverse sectional view, along line A-A, of a portion of the machine of FIG. 2;

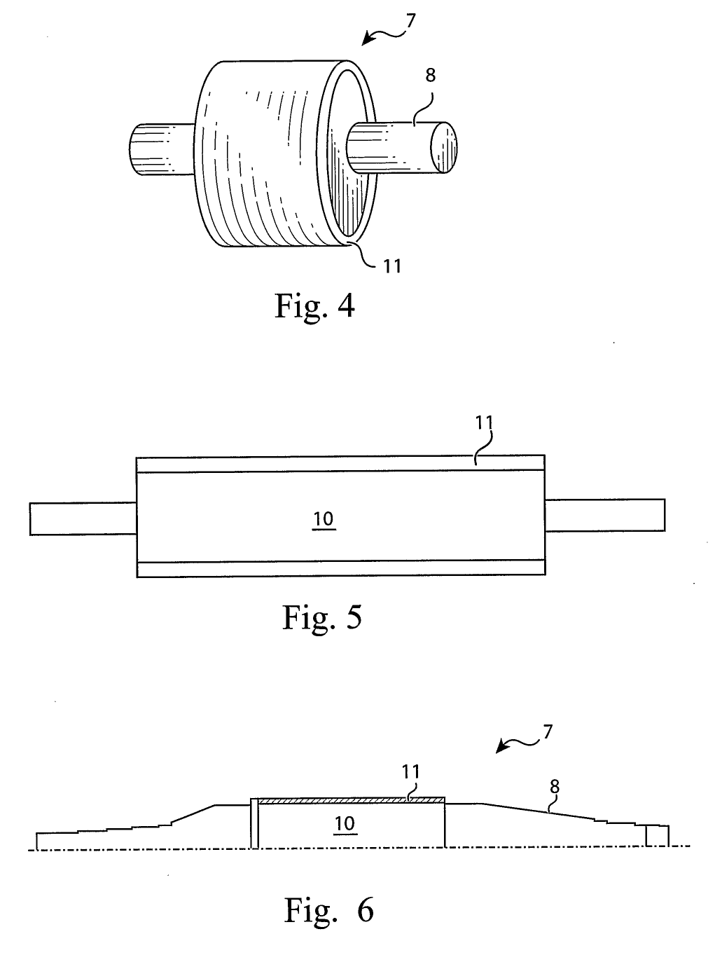

FIG. 4 schematically shows, not to scale, a perspective view of the rotor employed in the machine of FIG. 2;

FIG. 5 schematically shows, not to scale, a longitudinal sectional view of the rotor of FIG. 4;

FIG. 6 shows a working drawing of half of the section of the rotor employed in the machine of FIG. 3;

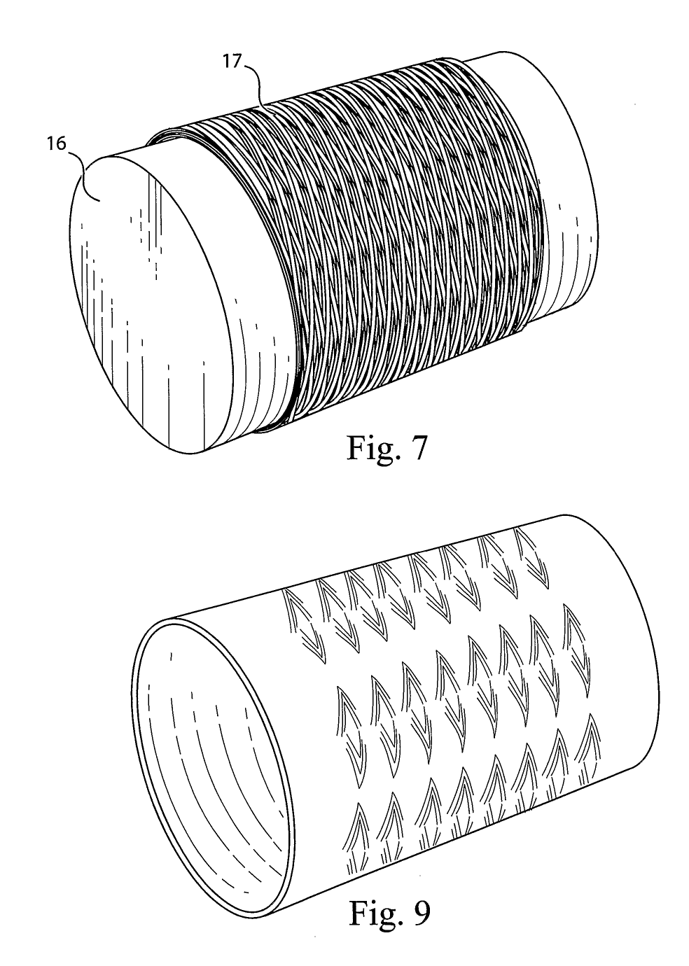

FIG. 7 shows a first semifinished product from the process for manufacturing the rotor of FIG. 4;

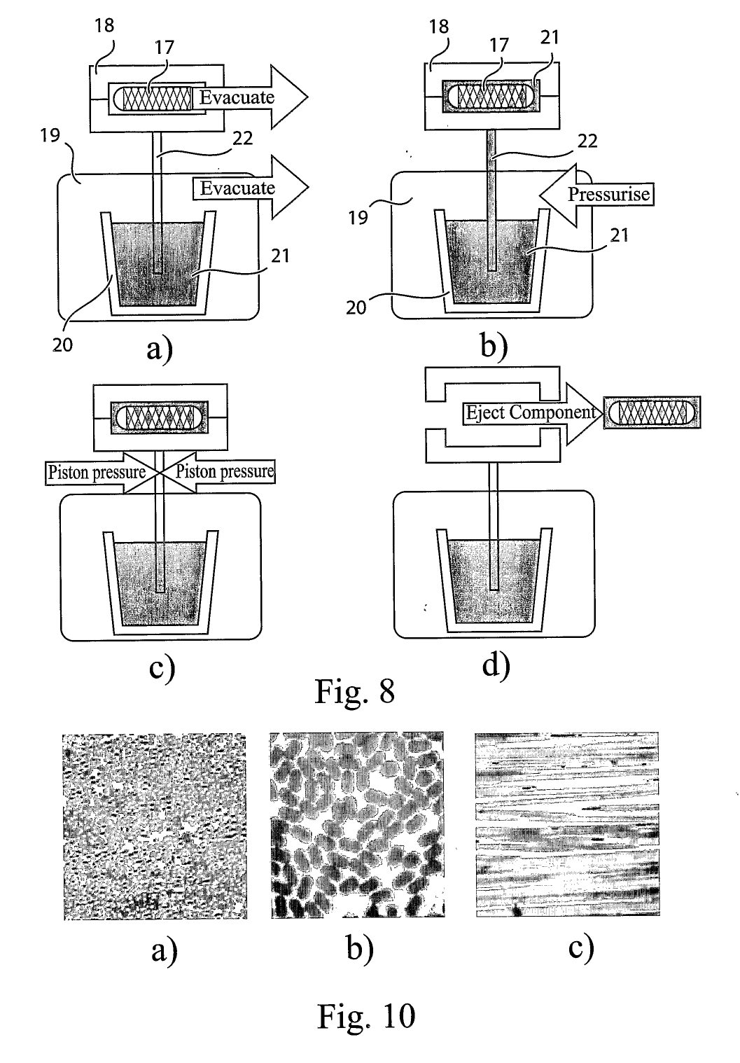

FIG. 8 schematically shows some steps of the process for manufacturing the rotor of FIG. 4;

FIG. 9 shows a second semifinished product from the process for manufacturing the rotor obtained from the first semifinished product of FIG. 7; and

FIG. 10 shows three photomicrographs of same sections of the second semifinished product of FIG. 9.

In the Figures, alike elements are indicated by the same reference numbers.

The inventors have developed a new rotor integrating a containing cage with a conductive cage in a sole cylindrical jacket, through employing a conductive metal matrix incorporating reinforcing fibres. In particular, the rotor is made by using advanced materials and manufacturing processes.

FIG. 2 schematically shows, not to scale, a longitudinal sectional view of an induction machine employing a preferred embodiment of the rotor according to the invention. FIG. 3 shows a transverse sectional view, along line A-A, of the machine of FIG. 2. In particular, the machine of FIGS. 2 and 3 is a high speed poly-phase alternating current induction machine, or HSIM (High Speed Induction Machine) machine. From FIGS. 2 and 3, it may be observed that the machine comprises a cylindrical stator 5, integrally coupled to a fcopper 6 (not shown in FIG. 3), within which a cylindrical rotor 7 is housed, coaxially to the stator 5, provided with a shaft 8 mechanically coupled to an external electro-mechanical machine. An air gap 9 is present between the stator 5 and the rotor 7. In particular, faced surfaces of the stator 5 and the rotor 7 are appropriately extremely smooth in order to reduce the friction of the air over the surface of the rotor 7 and, consequently, to limit the temperature and thermal instability of the rotor 7.

The external electromechanical machine may be a turbine, and in this case the HSIM machine of FIGS. 2 and 3 operates as a generator, or it may be a compressor or a pump, and in this cass the HSIM machine operates as a motor. In particular, when the HSIM machine of the Figures operates as a generator, the rotor 7 is capable to operate atrotational speeds up to about 30,000-35,000 rpm, providing an electrical power ranging from 800 to 1500 kW at a frequency of 500-600 Hz (assuming the minimum pole number, that is 2 poles).

FIGS. 4 and 5 schematically show, not to scale, a perspective view and a longitudinal sectional view, respectively, of the rotor 7 employed of the machine of FIGS. 2 and 3.

The core 10 of the rotor 7 is integrated enbloc with the shaft 8 through a high quality steel forging.

The rotor 7 according to the invention represents a technical solution extremely advanced with respect to conventional induction machines. In fact, the rotor 7 further comprises a cylindrical jacket 11 made of an aluminium matrix composite material, or AMC (Aluminum Matrix Composite). In particular, the AMC material used for producing the thin cylindrical jacket 11, which is both the containing cage and the conductive cage, is manufactured and mounted on the core 10 of the rotor 7 according to a process that will be described later.

The HSIM machine of FIGS. 2 and 3 further comprises a system for varying the electrical frequency (generated by the machine when it operates as a generator, or given as power supply to the machine when it operates as a motor), not shown in the Figures. In fact, the high rotational speed of the rotor 7, of the order of 30,000-35,000 rpm, imposes, even in the most favourable case of machine with minimum pole number (equal to 2), an electrical frequency equal to 500-600 Hz, which is well above the mains frequency (tipically ranging from 50 to 60 Hz). In particular, the electrical frequency variation system is similar to those already employed in conventional induction motors, and it is preferably a pulse width modulation or PWM type static converter, comprising semiconductor rectifier and inverter.

Preferably, the stator 5 is manufactured with a magnetic lamination core provided with a poly-phase winding coil system. Dimensions of the preferred embodiment of the stator 5 comprise a height of about 300 mm (substantially equal to the height of the core 10 of the rotor 7), an inner diameter of about 160 mm, and an outer diameter of about 460 mm. As shown in FIG. 3, the stator 5 comprises 24 teeth 12, among which 24 shaped cylindrical channels 13 with substantially trapezoidal section are present, and two series of 24 circular ducts, respectively 14 and 15, arranged at two radially different distances from the axis of the stator 5. The channels 13 and the ducts 14 and 15, along with the gap 9 and the gap (not shown in the Figures) between the outer surface of the stator 5 and the fcopper 6, are the flow paths of a cooling system similar to that of the conventional induction machines. In particular, the cooling system comprises an external centrifugal electrical blower (not shown in the Figures) that blows air along such flow paths which are interposed between two openings (also not shown) of the fcopper 6. Preferably, the electrical blower is sized so as to ensure that the temperatures of the active parts of the HSIM machine (mainly of iron and copper) are within the thermal class F siano all'interno della classe termica F, and the temperatures of the insulating winding structures of the stator 5 are within the thermal class H.

The mechanical characteristics of the steel alloy of the piece integrating the core 10 and the shaft 8 of the rotor 7 are such to support the stress resulting from the centrifugal forces present at high rotational speed, of the order of 30,000-35,000 rpm; the magnetic characteristics of this alloy are apt to support the magnetic flux without excessive saturation. In particular, this steel alloy in the preferred embodiment of the rotor 7 comprises: nickel for 1,8-2,3%, chromium for 0,9-1,6%, molybdenum for 0,3-0,6%, carbon for 0,2-0,3%, and manganese for 0,3-0,7%. The magnetic characteristics of this rotor 7 are such that: for a magnetic field of 2300 A/m, the magnetic flux density is above 1,4 T; for a magnetic field of 5200 A/m, the magnetic flux density is above 1,6 T; for a magnetic field of 13000 A/m, the magnetic flux density is above 1,8 T. The coefficient of thermal expansion of this steel alloy ranges from 11 to 13 ppm/° C. The outer diameter of the core 10 of the rotor 7 is just above about 134 mm.

The cylindrical jacket 11 of the preferred embodiment of the rotor 7 comprises pure aluminium for 60% volume, possibly comprising copper for about 2 wt. %, and alumina (Al₂O₃) fibres, preferably (but not necessarily) continuous and monofilament (alternatively they could be also multifilament and/or discontinuous fibres, such as particles, whiskers, or short fibres), substantially arranged around the cylinder circumference along substantially all the height of the same cylinder. The alumina fibres have a very low electrical conductivity and are effectively electrical insulators. The jacket 11 has a Young modulus in the fibre direction equal to about 240 Gpa, has the magnetic permeability of the air, an average coefficient of thermal expansion in the fibre direction equal to about 7 ppm/° C., and an average coefficient of thermal expansion in the transverse direction equal to about 16 ppm/° C. In particular, the dimensions of the jacket 11 of the preferred embodiment of the rotor 7 comprise a height of about 300 mm (substantially equal to the height of the core 10 of the rotor 7), an inner diameter of about 134 mm, an outer diameter of about 150 mm, a density of about 3,5 g/cc, and a total mass of about 3,64 Kg. Also other embodiments of the jacket 11, having similar heights and outer diameters, present a thickness of the cylinder walls of about 10 mm.

Pure aluminium (possibly comprising copper about 2 wt. %) used for the matrix, also owing to its low melting point, does not interact with the reinforcing fibres, the mechanical performance of which thus remain unchanged. Moreover, alumina fibres have a high stability in temperature and are particularly compatible with the matrix of pure aluminium (possibly comprising copper). By way of example, Nextel 610™ alumina fibres of the 3M company may be used for making the jacket 11. The preferred embodiment of the rotor 7 shows optimum mechanical performance at high operational speeds and optimum electrical performance, even at operational speeds up to about 35,000 rpm and at temperature up to 300° C.

Other embodiments of the rotor 7 according to the invention may comprise, as an alternative to or in combination with pure aluminium, other conductive materials for the matrix, such as for instance an aluminium-silicon alloy, and/or an aluminium-copper alloy, and/or an alloy of aluminium and/or copper and/or magnesium and/or titanium and/or zinc and/or lead. Similarly, reinforcing fibres may comprise, as an alternative to or in combination with alumina fibres, other fibres, such as for instance multifilament carbon fibres and/or monofilament silicon fibres. Furthermore, volume percentage of the metallic matrix may vary within the range from 10% to 75%, more preferably from 50% to 60%.

In particular, FIG. 6 shows a working drawing of half of the section of the preferred embodiment of the rotor 7. Experiments carried out by the inventors have shown that the first bending resonance mode occurs at a rotational speed of about 15,000 rpm, while the second bending resonance mode occurs at a rotational speed of about 45,000 rpm. Therefore, at the planned operational speeds of about 30,000-35,000 rpm, the rotor 7 operates between the first and the second lateral resonance and, according to the standard definitions, it may be considered as a “flexible rotor”.

The HSIM machine of FIGS. 2 and 3 further comprises bearings similar to those of conventional induction machines. The distance between the bearings axes of the preferred embodiment of the rotor 7 is about 830 mm. Preferably, the bearings are grease lubricated single row radial ball bearings, with a specific preload for the specific induction machine to which they are applied, i.e. a preload that takes account of dimensions and weight and operation conditions of the rotor 7.

The rotor 7 is manufactured according to the process described in the following.

The sole piece integrating the core 10 and the shaft 8 is obtained by suitably machining the material according to known techniques.

With reference to FIG. 7, it may be observed that the cylindrical jacket 11 of the preferred embodiment of the rotor 7 is manufactured starting from a first semifinished product obtained by winding, around a sacrificial cylinder 16, preferably in graphite, the reinforcing fibres 17, substantially orientated according to a substantially circumferential direction of the sacrificial cylinder 16.

Other embodiments may further provide that the reinforcing fibres 17 are orientated according to any other direction, including the axial direction of the sacrificial cylinder 16.

FIG. 8 schematises successive manufacturing steps.

First of all, as schematised in FIG. 8a, the cylinder 16 provided with the fibres 17 is inserted into a heated cylindrical die 18 of a casting system further comprising a chamber 19 provided with a crucible 20 containing the material 21 to be injected into the die, i.e. aluminium, pure or possibly provided with copper for about 2 wt. %. Afterwards, the die 18 is closed by using a mechanical locking system and a high vacuum condition is created in the casting system, by evacuating both the die 18 and the chamber 19 (in a period of the order of 10 seconds).

As schematised in FIG. 8b, molten aluminium 21 is transferred from the crucible 20 into the die 18 via a riser tube 22 through the introduction of high-pressure nitrogen gas into the chamber 19. In this way, molten aluminium 21 assumes the shape of the cylindrical die 18, filling the space included between the outer wall of the sacrificial cylinder 16 and the inner wall of the die 18, and infiltrating the fibres 17 filling all the interstices.

As schematised in FIG. 8c, a final consolidation is then carried out through activation of two high-pressure hydraulic pistons, interacting with the material present in the riser tube 22, which furthermore ensure total and homogeneous infiltration of molten aluminium 21 into the fibres 17 in a few seconds.

Finally, as schematised in FIG. 8d, the casting system is taken back to pressure conditions compatible with the outside and the thus obtained cylindrical jacket 11 is released.

Subsequently, the external surface of the jacket 11 is turned by using a diamond tooling, to expose the surface of the fibres 17, and finally the sacrificial cylinder 16 is removed thorugh conventional mechanical machining. In particular, other sacrificial materials may be used, instead of graphite, having appropriate properties of stability at the temperature and pressure conditions of the various manufacturing steps, and apt to be easily removed, for instance through a mechanical and/or chemical machining.

After removal of the cylinder 16, the internal surface of the jacket 11 is ground. In particular, the cylindrical jacket 11 finally obtained from the semifinished product of FIG. 7 is shown in FIG. 9.

FIG. 10 shows three photomicrographs of some sections of the jacket 11 of FIG. 9. In particular: FIG. 10a shows a first photomicrograph of a section of the jacket 11 along an axial plane with a first magnification level; FIG. 10b shows a second photomicrograph of a section of the jacket 11 along an axial plane with a second magnification level; and FIG. 10c shows a third photomicrograph of a section of the jacket 11 along a radial plane. FIG. 10 shows that fibres are distributed in a substantially uniform way into the aluminium matrix, with no evidence of significant porosity of the same matrix. In particular, FIG. 10 shows that fibres used in the preferred embodiment of the jacket 11 are continuous filaments of high purity nanocrystalline alumina with diameter ranging from about 10 to 12 μm, which have a stiffness and a longitudinal strength comparable to steel alloys, even if they have a density only slightly higher than aluminium.

The core 10 of the rotor 7 has an outer diameter ranging from 134,140 mm to 134,170 mm, while the jacket 11 has an inner diameter ranging from 134,000 mm to 134,025 mm. Consequently, in order to mount the jacket 11 on the core 10 of the rotor 7, it is necessary to take these two components at different temperatures so as to make the outer diameter of the core 10 lower than the inner diameter of the jacket 11. Since the fibres 17 have a low expansion capacity when heated, the core 10 of the rotor 7 is cooled at −190° C. in a liquid nitrogen bath; the cylindrical jacket 11, preliminarily heated in an oven at 100° C., is then mounted on the core 10 of the rotor 7.

When the core 10 and the jacket 11 are taken back at room temperature, the maximum and the minimum differences between the diameters of the interacting surfaces of them are equal to, respectively, 0,170 mm (equal to 0,127% of the diameter of the core 10) and 0,115 mm (equal to 0,086% of the diameter of the core 10), producing a maximum value of the torsion stress during operation is equal to 100 MPa, which is well below the maximum tolerable value. Moreover, the difference between the thermal expansion coefficients of the jacket 11 and the core 10 are such that, at the operation temperatures of the rotor 7, the mechanical stress that they create between them, due to thermal expansion, are within acceptable values, and the torque transmission from the shaft 8 to the jacket 11 is always efficient.

The great advantages offered by the rotor according to the invention are numerous.

First of all, it has an enhanced heat dissipation, owing to the high degree of heat dissipation of the materials forming the jacket 11.

Moreover, the reinforcing fibres of the jacket 11 increase the mechanical resistance, up to 100%, and the stiffness, up to 200%, of the rotor with respect to conventional rotors, also giving it a high tensile strength, thus allowing its use at high speeds and, consequently, the direct coupling of the rotor shaft 8 to the shaft of an external electro-mechanical machine, such as for instance a gas turbine operating up to 35,000 rpm. This reduces acoustic noise emissions of the induction machine to which it is applied, owing to the elimination of the reduction gearbox needed by conventional machines.

Still, the rotor according to the invention has a reduced electrical resistance and optimum magnetic properties, further enhanceable by doping rotor materials (in both the core 10 and the jacket 11) through addition of specific substances.

Furthermore, it allows a significant increase of the efficiency of the machine, not lower than 10%, with respect to conventional values, and it increase its reliability, owing to the elimination of the reduction gearbox and to its excellent electrical and magnetic properties.

Also, the rotor according to the invention allows a reduction of the manufacturing, installation and maintenance costs of the induction machine to which it is applied, since the costs of the jacket fibres and of the rotor manufacturing process are absolutely marginal, because such costs in conventional machines are mainly due to the presence of the reduction gearbox.

Still, the environmental impact of an induction machine employing the rotor according to the invention is substantially null, since the elimination of the reduction gearbox further eliminates the need for lubricants of this.

Furthermore, the rotor according to the invention is compact and lightweight, allowing construction of induction machines lighter up to 60% and smaller up to 50% than equal power conventional ones, thus reducing the employed material and also improving the power to weight ratio. Consequently, such machines have a high portability and adaptability to a very wide range of applications, such as for instance in oil platforms, in emergency generation systems for hospitals, in naval plants, in civil plants placed in islands, deserts or mountain zones not served by an efficient electrical grid. In particular, the rotor according to the invention is applicable to generators of any power, even to those above 20 MW.

Moreover, the low thermal expansion coefficient of the rotor, in particular of the jacket 11, allows a stable rotor behaviour with temperature and a reduction of mechanical stress and deformations at operation temperatures.

The process for manufacturing the rotor 7, described with reference to FIG. 8, also offers great advantages.

First of all, it has a very short cycle time, of the order of few minutes.

Furthermore, use of high vacuum in the step schematised in FIG. 8a degases the molten material 21 in the crucible 20, minimising (when not completely eliminating) the trapped gas in the die 18 and the porosity of the molten material 21 and, consequently, the trapped gas within the jacket 11 and the porosity thereof.

Moreover, two-stage pressurisation, i.e. the two steps schematised in FIGS. 8b and 8c, ensures that there is no fibre damage or fibre displacement during infiltration of the molten aluminium 21, producing a regular and controlled size of the obtained metallic grains.

Still, the molten material 21 is accurately metered, minimising wastage and leakage of the same molten material 21, eliminating the risk that the die 18 clogs or jams.

Finally, it is not necessary to super-heat the material to be molten, and the process is environmentally clean.

The preferred embodiments have been above described and some modifications of this invention have been suggested, but it should be understood that those skilled in the art can make variations and changes, without so departing from the related scope of protection, as defined by the following claims.

1. Rotor (7) for induction machines, comprising a core (10), apt to face a stator (5) of an induction machine, and an axis (8) that is coaxial with the core (10), characterised in that the core (10) and the axis (8) are made enbloc, and in that it further comprises a jacket (11) externally integrally coupled to the core (10), the jacket (11) comprising conductive metallic matrix incorporating reinforcing fibres (17).

2. Rotor according to claim 1, characterised in that the volume percentage of the metallic matrix ranges from 10% to 75% of the jacket (11).

3. Rotor according to claim 2, characterised in that the volume percentage of the metallic matrix ranges from 50% to 60% of the jacket (11).

4. Rotor according to claim 1, characterised in that the metallic matrix is made of at least one metallic material selected from the group comprising pure aluminium, aluminium-copper alloy, aluminium-silicon alloy, and alloy of aluminium and/or copper and/or magnesium and/or titanium and/or zinc and/or lead.

5. Rotor according to claim 4, characterised in that the metallic matrix is made of pure aluminium.

6. Rotor according to claim 4, characterised in that the metallic matrix is made of aluminium comprising copper for about 2 wt. %.

7. Rotor according to claim 1, characterised in that the reinforcing fibres (17) comprise continuous fibres and/or discontinuous fibres.

8. Rotor according to claim 1, characterised in that the reinforcing fibres (17) comprise monofilament fibres and/or multifilament fibres.

9. Rotor according to claim 1, characterised in that the reinforcing fibres (17) comprise at least one type of fibres selected from the group comprising alumina fibres, carbon fibres, silicon fibres.

10. Rotor according to claim 9, characterised in that the reinforcing fibres (17) comprise substantially electrically insulating fibres.

11. Rotor according to claim 10, characterised in that the reinforcing fibres (17) comprise nanocrystalline fibres.

12. Rotor according to claim 11, characterised in that the nanocrystalline reinforcing fibres (17) have a diameter ranging from 10 to 12 μm.

13. Rotor according to claim 12, characterised in that the reinforcing fibres (17) are monofilament continuous alumina fibres.

14. Rotor according to claim 1, characterised in that the core (10) and the axis (8) are made of a steel alloy.

15. Rotor according to claim 14, characterised in that the steel alloy of the core (10) and the axis (8) comprises at least one metallic material selected from the group comprising nickel, chromium, molybdenum, carbon, and manganese.

16. Process for manufacturing a rotor according to claim 1, characterised in that it comprises the following steps:
A. making the sole piece integrating the core (10) and the axis (8);
B. winding the reinforcing fibres (17) around a sacrificial cylinder (16), which has a diameter lower than the diameter of the core (10), obtaining a first semifinished product;
C. inserting the first semifinished product into a heated die (18) of a casting system, further comprising a chamber (19) provided with a crucible (20) containing the metallic material (21) of the matrix;
D. mechanically closing the die (18) and creating a high vacuum condition in the casting system, by evacuating both the die (18) and the chamber (19);
E. transferring the metallic material (21) from the crucible (20) into the die (18) via a riser tube (22) through the introduction of high-pressure nitrogen gas into the chamber (19);
F. removing the sacrificial cylinder (16), obtaining the jacket (11);
G. cooling the core (10) at a first temperature at which its diameter is not larger than the jacket diameter at a second temperature; and
H. mounting the jacket (11) on the core (10).

17. Process according to claim 16, characterised in that it further comprises, between step E and step F, a step of consolidating the metallic material (21) through activation of at least one high-pressure hydraulic piston.

18. Process according to claim 16, characterised in that it further comprises, after step E and before step H, a step of turning the external surface of the jacket (11).

19. Process according to claim 16, characterised in that it further comprises, after step F and before step H, a step of grinding the internal surface of the jacket (11).

20. Process according to claim 16, characterised in that in step G the core (10) is cooled in a liquid nitrogen bath.

21. Process according to claim 16, characterised in that said first temperature is equal to —190° C.

22. Process according to claim 16, characterised in that said second temperature is room temperature.

23. Process according to claim 16, characterised in that said second temperature is higher than room temperature, the jacket (11) being heated for assuming said second temperature.

24. Process according to claim 23, characterised in that said second temperature is equal to 100° C.

25. Induction machine, comprising a cylindrical stator (5), provided with winding coils, and a rotor (7), that is coaxial with the stator (5), between which an air gap (9) is present, characterised in that the rotor is a rotor according to claim 1, the axis (8) of the rotor (7) being apt to be coupled to an external electro-mechanical machine.

26. Machine according to claim 25, characterised in that it further comprises an electrical frequency variation system interposed between, and connected to, the winding coils of the stator (5) and an external mains.

27. Machine according to claim 26, characterised in that said electrical frequency variation system comprises a pulse width modulation or PWM type static converter, comprising semiconductor rectifier and inverter.

28. Machine according to claim 25, characterised in that the stator (5) is made with a laminated magnetic core.

29. Machine according to claim 25, characterised in that the stator (5) comprises at least one series of ducts, operating as flow paths of a cooling system of the machine further comprising air blowing means.

30. Machine according to claim 25, characterised in that it further comprises grease lubricated single row radial ball bearings, apt to be adjustably preloaded.

31. Machine according to claim 25, characterised in that it is apt to operate at rotor speeds up to about 35.000 revolutions per minute, or rpm.

32. Machine according to claim 25, characterised in that it is a poly-phase alternating current machine.

33. Machine according to claim 25, characterised in that said external electromechanical machine, to which the axis (8) of the rotor (7) is apt to be coupled, is a turbine, the induction machine operating as a generator, or a compressor or a pump, the induction machine operating as a motor.
